(19) United States
(12) Patent Application Publication
(10) Pub. No.: US 2015/0169776 A1
(43) Pub. Date: Jun. 18, 2015

(54) SYSTEM AND METHOD FOR DISPLAYING CONTEXTUAL DATA RESPECTIVE OF EVENTS

(71) Applicant: MAINSOFT R&D LTD., Lod (IL)

(72) Inventor: Roy Sheinfeld, Tel Aviv (IL)

(73) Assignee: MAINSOFT R&D LTD., Lod (IL)

(21) Appl. No.: 14/569,937

(22) Filed: Dec. 15, 2014

Related U.S. Application Data
(60) Provisional application No. 61/916,871, filed on Dec. 17, 2013.

(51) Int. Cl. G06F 17/30; G06Q 10/10; H04L 29/08

(52) U.S. Cl. CPC G06F 17/30867; H04L 67/02; G06Q 10/1093

(57) ABSTRACT

A system and method for searching and displaying contextual data respective of an event is provided. The system comprises receiving a request to analyze calendar data stored on a user device, wherein the calendar data comprises the event; generating metadata for the event based on the analyzed calendar date; identifying at least one parameter related to the event; searching through a plurality of web sources for contextual data related to the at least one identified parameter; and providing the contextual data to the user device.

### CROSS-REFERENCE TO RELATED APPLICATIONS

This application claims the benefit of U.S. Provisional Application No. 61/916,871 filed on Dec. 17, 2013, the contents of which are hereby incorporated by reference.

### TECHNICAL FIELD

The present invention relates generally to providing contextual data to users and, more particularly, to providing contextual content from cloud and web sources based on analyses of calendar data existing on user devices.

### BACKGROUND

The maturity of the Internet as a business network and the proliferation of mobile devices as professional workstations have intersected to produce the first anywhere, anytime platform for enterprise operations. But anywhere, anytime operations come at a cost. The ubiquitous access to information via cloud services, enterprise applications, and social networking tools has created information overload. Workers today struggle to fend off the deluge of data coming from an increasing number of sources, a deluge that leads to missed information, much lower productivity, and even stress-related illness.

In particular, employees at a company or other individuals associated with a larger group that holds frequent meetings may be inundated with information regarding upcoming meetings. In some cases, many of these meetings are either far in the future or do not actually require a particular person's involvement. Nevertheless, a person may be informed about such a meeting by, e.g., a message that is indiscriminately sent out to all members of the group or company. If the person receives many such messages that include information about meetings that he or she will not need to attend, the numerous irrelevant messages may cause additional inconvenience to the person.

It would therefore be advantageous to provide a solution that would overcome the deficiencies of the prior art by collecting data from a plurality of web-based systems. It would be further advantageous if the data is provided respective of the user's immediate needs and requirements.

### SUMMARY

A summary of several example aspects of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all aspects. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

The disclosure relates to exemplary embodiments of a method and system for searching and displaying contextual data respective of an event. The method comprises receiving a request to analyze calendar data stored on a user device, wherein the calendar data comprises the event; generating metadata for the event based on the analyzed calendar date; identifying at least one parameter related to the event; searching through a plurality of web sources for contextual data related to the at least one identified parameter; and providing the contextual data to the user device.

In some exemplary embodiments the system comprises a processor; and a memory, the memory containing instructions that, when executed by the processor, configure the system to: receive a request to analyze calendar data stored on a user device, wherein the calendar data comprises the event; generate metadata for the event based on the analyzed calendar date; identify at least one parameter related to the event; search through a plurality of web sources for contextual data is related to the at least one or more identified parameters; and provide the contextual data to the user device.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a network system utilized to describe the various disclosed embodiments;

FIG. 2 is a flowchart illustrating displaying contextual data respective of at least one event according to an embodiment; and

FIG. 3 is a flowchart illustrating searching for contextual data respective of one or more parameters related to an event according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

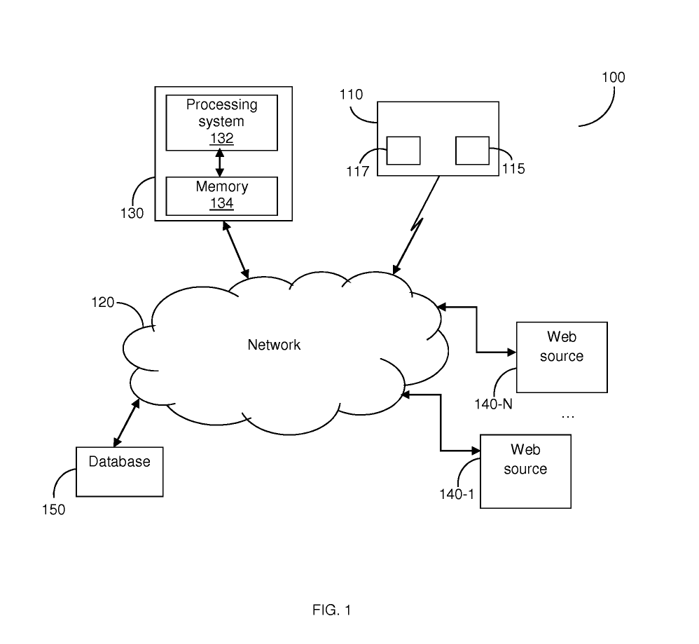

FIG. 1 shows an exemplary and non-limiting schematic diagram of a network system 100 utilized to describe the various disclosed embodiments. The network system 100 includes a user device 110, a network 120, a server 130, a plurality of web sources 140-1 through 140-n, and a database 150. The user device 110 is communicatively connected to the network 120. The user device 110 may be, for example, a personal computer, a tablet computer, a laptop computer, a smart phone, a wearable computing device and so on. The network 120 may be wireless, cellular or wired, a local area network (LAN), a wide area network (WAN), a metro area network (MAN), the Internet, the worldwide web (WWW), and any combination thereof.

The user device 110 typically includes an agent 115 installed thereon and at least one calendar data storage unit (CDU) 117. According to an embodiment, the CDU 117 contains data related to a plurality of calendars stored therein. The agent 115 is communicatively connected to the server 130 over the network 120. The agent 115 may realize as executable instructions saved in a memory and executed by a processor or the user device 110. As not limiting example, the agent 115 may include, but not limited to, a software application (App) installed in the device 110, and add-on or a plug-in for existing calendar applications. For example, the agent may be a plug to Microsoft® Outlook®.

According to an embodiment, the agent 115 is configured or programmed to collect data stored in the CDU 117. The data comprises information respective of at least one event. The agent 115 then sends the data to the server 130. The server 130 is configured to analyze the data and generate metadata respective of the at least one event. According to another embodiment, the analysis is performed by the agent 115 on the user device 110. The agent 115 is also configured generates metadata respective of the event and sends the generated metadata to the server 130.

In an embodiment, the server 130 is configured to identify one or more parameters related to the at least one event. The parameters may be, but are not limited to, participants in the event, a location of the event, a subject of the event, a type of event, comments received by potential participants respective of the event, and so on. Using the identified parameters, the server 130 is also configured to search for contextual data from web sources 140-1 through 140-N (hereinafter referred to individually as a web source 140 or collectively as web sources 140).

The web sources 140 may be public web sources or private web sources. A private web source may be, for example, an enterprise's web source. The web sources 140 may be selected by a user of the user device 110 to perform the search. The selection may include identifiers of the user which enable the server 130 to extract contextual data from private web sources 140 that the user can access. Different searches may be appropriate respective of different categories of identified parameters. As a non-limiting example, a search for contextual data related to the category “type of an event” may be appropriately performed through a private web source 140 and a search for contextual data related to the category “location of an event” may be appropriately performed through a public web source 140.

The contextual data found by the server 130 through the web sources 140 is displayed on the user device 110. In an embodiment, the server 130 is further configured to identify one or more environmental variables. The environmental variables may include, for example, a time of day of the analysis, a location of the user device 110, and so on. Based on the environmental variables and the one or more identified parameters, the server 130 is also configured to determine when to display the contextual data on the user device 110. The system 100 may further include a database 150 for storing contextual data found together with the related parameters.

In some implementation, the server 130 typically comprises a processing system 132 that is coupled to a memory 134. The memory 134 contains instructions that when executed by the processor system 132 results in the performance of the methods discussed herein below. Specifically, the memory 134 may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). In an embodiment, the processing system 132 may include one or more processors. The instructions, when executed by the one or more processors, cause the processing system 132 to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

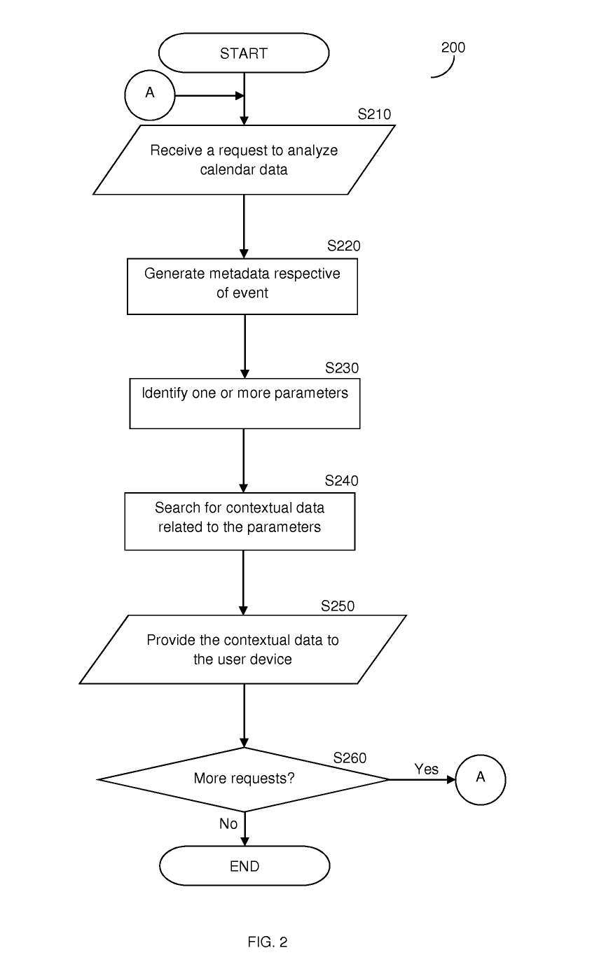

FIG. 2 is an exemplary and non-limiting flowchart 200 illustrating display of contextual data respective of events according to an embodiment. The method may be performed by the server 130.

In S210, a request to analyze data stored in, for example, a CDU (e.g., the CDU 117) is sent to a user device. In S220, metadata respective of at least one event is received by the server. In an embodiment, an analysis may be conducted respective of the CDU, by the agent, to identify the at least one event and its corresponding metadata.

In S230, respective of the identified metadata, parameters related to the event are identified. Such parameters may include, but are not limited to, participants in the event, a location of the event, a subject of the event, the type of event, and so on.

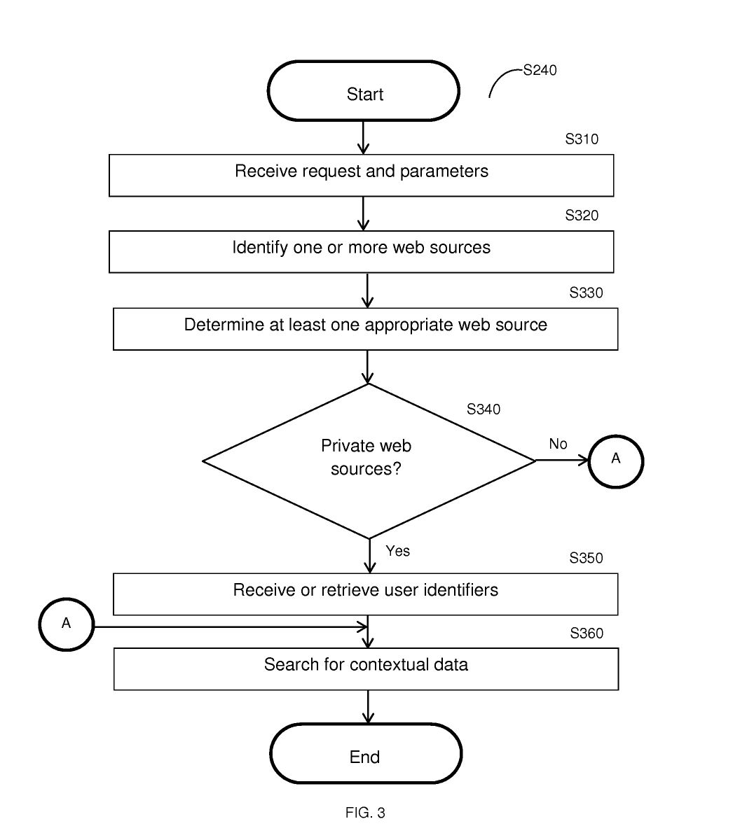

In S240, a search for contextual data respective of the identified parameters is performed through one or more web sources (e.g., the web sources 140). Searching for contextual data respective of parameters related to an event is described further herein below with respect to FIG. 3.

In S250, contextual data found via the search is provided to a user device (e.g., the user device 110) for display. As a non-limiting example, in case the topic of the meeting identified as “financial planning for 2015” contextual data respective such topic may be financial data and respective sheets. Therefore, financial reports of past years are sent for display on the user device 110. As another example, the participants may be identified and contextual data related to each participant, role, age, picture, etc. are displayed on the user device 110.

In S270, it is checked whether additional requests have been received and, if so, execution continues with S210; otherwise, execution terminates.

As a non-limiting example, calendar data existing on a user device is analyzed by an agent installed on the user device 110. Based on the analysis, metadata respective of an event associated with calendar data of the user device is generated. The analysis may include, for example, extraction of one or more indices that were predetermined as descriptive respective of an event from a database communicatively coupled to the agent 115. The analysis further includes term mining through the calendar data. For example, the term “agenda” in a query structure is expected to be followed by the topic of an event. The metadata is then sent to a server. The server analyzes the metadata and, based on the analysis, the type of the event is identified as a marketing meeting and a name of a participant in the meeting is identified as John Smith. The day of the meeting identified as Jan. 1, 2014. Respective thereto, public web sources are searched for contextual data related to John Smith, and private web sources are searched for the latest data related to marketing issues. The contextual data that is found via the search is provided to the user of the user device prior to the meeting on Jan. 1, 2014.

FIG. 3 is an exemplary and non-limiting flowchart S240 illustrating searching for contextual data respective of parameters related to an event according to an embodiment. In an embodiment, the search for contextual data is conducted via one or more web sources (e.g., web sources 140). In S310, a request to search for contextual data related to an event and parameters related to the event are received. Parameters related to an event may be, but are not limited to, participants in the event, the location of the event, the subject of the event, the type of event, and so on.

In S320, one or more web sources from which contextual data related to an event may be extracted for the user is identified. The one or more web sources may be, but are not limited to, a private web source, a public web source, and so on. In an embodiment, the identification may be based on, e.g., web sources the user has previously accessed, and web sources on a list of preferred web sources. In another embodiment, the identification may include prompting a user for web sources from which to extract contextual data related to an event and, upon receiving a response from the user, identifying the web sources in the response.

In S330, based on a category of parameter, at least one appropriate web source through which to search for the received parameter is determined. Different web sources may be determined to be appropriate respective of different categories of identified parameters. For example, a search for contextual data related to the category “type of an event” may be appropriately performed through one or more private web sources and a search for contextual data related to the category “location of an event” may be appropriately performed through one or more public web sources.

In S340, it is determined whether one or more of the identified web sources is a private web source. If so, execution continues with S350; otherwise, execution continues with S360. In 350, identifiers of the user for obtaining access to the identified private web sources are received or retrieved. The identifiers of the user may be, e.g., received from the user, retrieved from a database, and so on.

In S360, the at least one appropriate web source respective of each received parameter is searched for contextual data related to the parameter. Such a search may include, but is not limited to, using metadata associated with the one or more parameters of the event as search inputs in the at least one appropriate web source.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for searching and displaying contextual data respective of an event, comprising:
receiving a request to analyze calendar data stored on a user device, wherein the calendar data comprises the event;
generating metadata for the event based on the analyzed calendar date;
identifying at least one parameter related to the event;
searching through a plurality of web sources for contextual data related to the at least one identified parameter; and
providing the contextual data to the user device.

2. The method of claim 1, wherein the at least one identified parameter is any one of:
a participant in the event, a location of the event, a subject of the event, and a type of the event.

3. The method of claim 1, further comprising:
storing the contextual data and the at least one parameter in a database.

4. The method of claim 1, wherein the plurality of web sources comprises at least one of: public web sources and private web sources, wherein private web sources are limited to an enterprise the user belongs to.

5. The method of claim 1, wherein searching through the plurality of web sources for contextual data further comprises:
identifying at least one the of plurality of web sources from which contextual data may be extracted;
determining whether each web source of the plurality of web sources the identified at least one web source are appropriate respective of the identified parameters; and
upon determining a web source of data is appropriate respective of the identified parameters, searching through the appropriate source of data for contextual data.

6. The method of claim 5, further comprising:
determining whether each appropriate source of data is a private web source;
upon determining that an appropriate source of data is a private web source, obtaining at least a user identifier for accessing the appropriate private web source; and
accessing the appropriate private web source using the at least a user identifier.

7. The method of claim 6, wherein obtaining at least a user identifier for accessing the appropriate private web source further comprises:
prompting a user for the at least a user identifier; and
receiving the at least a user identifier from the user.

8. The method of claim 1, further comprising:
identifying at least one environmental variable;
determining, based on the identified at least one environmental variable, a time to display the contextual data on the user device; and
displaying the contextual data at the determined time.

9. The method of claim 8, wherein the at least one environmental variable is at least one of: a time of day and a location of the user device.

10. A non-transitory computer readable medium having stored thereon instructions for causing one or more processing units to execute the method according to claim 1.

11. A system for searching and displaying contextual data respective of an event, comprising:
a processor; and
a memory, the memory containing instructions that, when executed by the processor, configure the system to:
receive a request to analyze calendar data stored on a user device, wherein the calendar data comprises the event;
generate metadata for the event based on the analyzed calendar date;
identify at least one parameter related to the event;
search through a plurality of web sources for contextual data is related to the at least one or more identified parameters; and
provide the contextual data to the user device.

12. The system of claim 11, wherein the one parameter is at least one of: a participant in the event, a location of the event, a subject of the event, and a type of the event.

13. The system of claim 11, wherein the system is further configured to:
store the contextual data and the at least one parameter in a database.

14. The system of claim 11, wherein the plurality of web sources comprises at least one of: public web sources and private web sources, wherein private web sources are limited to an enterprise the user belongs to.

15. The system of claim 11, wherein the system is further configured to:
identify one the of plurality of web sources from which contextual data may be extracted;
determine whether each web source of the plurality of web sources the identified at least one web source are appropriate respective of the identified parameters; and
upon determining a web source of data is appropriate respective of the identified parameters, search through the appropriate source of data for contextual data.

16. The system of claim 15, wherein the system is further configured to:
determine whether each appropriate source of data is a private web source;
upon determining that an appropriate source of data is a private web source, obtain at least a user identifier for accessing the appropriate private web source; and
access the appropriate private web source using the at least a user identifier.

17. The system of claim 16, wherein the system is further configured to:
prompt a user for the at least a user identifier; and
receive the at least a user identifier from the user.

18. The system of claim 11, wherein the system is further configured to:
identify at least one environmental variable;
determine, based on the identified at least one environmental variable, a time to display the contextual data on the user device; and
displaying the contextual data at the determined time.

19. The system of claim 18, wherein the at least on environmental variable at least one any of: a time of day, and a location of the user device.
